(19) United States
(12) Patent Application Publication
(10) Pub. No.: US 2005/0217447 A1
(43) Pub. Date: Oct. 6, 2005

(54) Slitter device with adjustable blade

(75) Inventors: James Phillip Hollandsworth, Rural Hall, NC (US); Mark Allen Vernon, Winston-Salem, NC (US); Francis Rex Oakley, Kernersville, NC (US); Jerry Wayne Johnson, Dobson, NC (US); Terry Leonard Bullins, Walnut Cove, NC (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: R. J. Reynolds Tobacco Company

(21) Appl. No.: 10/814,820

(22) Filed: Mar. 31, 2004

(51) Int. Cl. B26D 1/24

(52) U.S. Cl. 83/499; 83/508.3

(57) ABSTRACT

A slitter device is provided having at least two substantially parallel rotatable shafts extending through corresponding cutting blades for cutting sheet material into ribbons. The cutting blades on at least one of the rotatable shafts are axially adjustable along the shaft to allow a cutting relation to be maintained between those blades relative to complementary cutting blades on the other rotatable shaft. The slitter device thus facilitates axial adjustment of the cutting blades without slitter device disassembly and with minimum down time.

### FIELD OF THE INVENTION

The invention relates to a device for slitting sheet material, and more particularly to a device for cutting a sheet material for use in the manufacture of tobacco products such as cigarettes.

### BACKGROUND OF THE INVENTION

Smoking articles, such as cigarettes, typically have a substantially cylindrical structure and include a charge, roll or column of smokable material such as shredded tobacco surrounded by a paper wrapper, thereby forming a tobacco rod.

The roll or column of tobacco used to fill the tobacco rod used in the manufacture of cigarettes may be cut from reconstituted tobacco sheet (such as, for example, R.J. Reynolds Tobacco Company so-called G-7 reconstituted tobacco sheet). Representative methods for making certain types of reconstituted tobacco sheet using papermaking-type processes are set forth, for example, in U.S. Pat. Nos. 3,847,164 to Mattina; 4,131,117 to Kite et al.; 4,182,349 to Selke; 4,308,877 to Mattina; 4,241,228 to Keritsis; 4,421,126 to Gellatly; 4,706,692 to Gellatly; 4,941,484 to Clapp et al.; 4,963,774 to Thomasson et al.; 4,987,906 to Young et al.; 5,056,537 to Brown et al.; 5,143,097 to Sohn et al.; 5,322,076 to Brinkley et al.; 5,325,887 to Young et al.; 5,377,698 to Litzinger; 5,445,169 to Brinkley et al.; 5,501,237 to Young et al.; and 5,533,530 to Young et al.; which are incorporated herein by reference.

In one representative process, the tobacco sheet, once formed from the tobacco pulp material, is then dried to about 12% moisture and has a temperature slightly greater than ambient before being directed to a downstream slitter device for slitting the sheet into ribbons of various widths such as, for example, on the order of about 1-3 inches wide. In some instances, the tobacco sheet, such as, for example, a G-7 reconstituted tobacco sheet, is about 85 inches wide (with standard thickness and basis weight of a reconstituted tobacco sheet) and is directed to travel at about 400 feet/minute to the slitter device.

Some slitter devices used in the production of tobacco products may have one or more rotating shafts with blades or knives attached thereto at intervals corresponding to the desired width of the ribbons that are to be cut from a sheet material. In multi-shaft slitters, first and second shafts are generally mounted in close proximity and have substantially parallel rotational axes. In these devices, the blades attached to the first shaft are configured to interact with corresponding blades attached to the second shaft. This configuration provides a precise shearing cut of the sheet material as it is directed through the slitter between the parallel rotating shafts. A two-shaft, complementary-blade arrangement has been described, for example, in U.S. Pat. No. 4,449,540 to Marshal et al., wherein a slitter-type machine is disclosed for cutting baled tobacco. According to the '540 patent, complementary circular blades on parallel shafts provide a shearing action to cut baled tobacco into sections of a specified width. In addition, U.S. Pat. No. 4,566,470 to Brackman discloses the general use of closely-spaced counter-rotating discs to shred fibrous tobacco stem material to produce tobacco material suitable for use in cigarette production.

After repeated contact with the sheet material and the various components therein, such as plant stem material, and other hardened particles, including soil and mineral components, the blades may begin to wear. Wear may also result from the interaction of complementary blades on opposing shafts. Blade wear may occur in a non-uniform manner such that, in some instances, certain blades may exhibit more wear than other blades on the same shaft. This wear can result in deterioration of slitter performance since the now axially-separated complementary blades can no longer provide the necessary cutting action to cleanly cut the sheet material.

Some tobacco cutting machines disclosed in the prior art, such as in U.S. Pat. No. 3,320,991 to Molins, provides a self-adjusting sharpening mechanism built into the machine for periodic re-sharpening of a collection of cutting blades attached to a single cutting drum. The Molins '991 patent does not, however, address blade wear on more than one shaft. Another single shaft tobacco cutting machine is disclosed in U.S. Pat. No. 3,322,175 to Ward, wherein a clamp for providing a consistent clamping force on cutting knives affixed to a single rotating drum is described. The Ward '175 patent, however, describes the clamp (or “heel plate”) as fitting within a fixed recessed portion formed in the outer surface of the rotating drum such that the clamps are only applicable to a particular location on the drum.

In some previous dual-shaft slitter machines having closely spaced cutting blades aligned on a shaft, realignment of complementary slitter blades into an appropriate cutting relation often requires dismantling of all or part of the slitter machine. Such a process includes, for example, removal of the blades from one of the shafts, and the addition of spacers to that shaft, between the blades, in order to bring the individual blades on the shaft back into the appropriate cutting/shearing positions relative to complementary blades on the opposing shaft. Such a dismantling and realignment process may be disadvantageous due to the labor-intensive nature of the process and resulting machine down time. In some instances, less than optimal alignment of the blades upon reassembly may undesirably necessitate one or more iterations of the realignment process.

Thus, there exists a need for a slitter device capable of compensating for blade wear without the associated disadvantages of exemplary prior art slitter devices as discussed.

### SUMMARY OF THE INVENTION

The above and other needs are met by the present invention, which, in one embodiment, provides a slitter device having substantially parallel first and second rotatable shafts. The first rotatable shaft is configured to extend axially through a first cutting blade. The second rotatable shaft is configured to extend axially through a second cutting blade. The slitter device provides for the second cutting blade to be selectively secured along the length of the second rotatable shaft as to allow the second cutting blade to be aligned in a cutting relation relative to the first cutting blade. Accordingly, as one or both of the cutting blades experience wear, the second cutting blade may be readily readjusted along the second rotatable shaft to maintain the cutting relation.

In one embodiment of the present invention, each axially-adjustable cutting blade is provided with a collar mechanism for securing the respective blade to the shaft. In other embodiments, a plurality of first and second cutting blades may be provided with the respective first and second rotatable shafts, typically in equal numbers such that each first cutting blade corresponds with a second cutting blade to form a set of complementary cutting blades, with at least one of the cutting blades being axially adjustable. In such instances, the axially adjustable cutting blade in each set of complementary cutting blades is independently and individually movable with respect to others of the axially adjustable cutting blades on that shaft. That is, a single one of the axially adjustable cutting blades on a rotatable shaft may be axially adjusted, independently of the remainder of the axially adjustable cutting blades on that shaft and without imparting an effect thereto or having an interaction therewith.

Thus, embodiments of the present invention provide significant advantages as further detailed herein.

### BRIEF DESCRIPTION OF THE SEVERAL VIEWS OF THE DRAWING(S)

Having thus described the invention in general terms, reference will now be made to the accompanying drawings which are not necessarily drawn to scale:

FIG. 1 shows a perspective view of a slitter device according to one embodiment of the present invention;

FIG. 2 shows a cross-sectional view of a slitter device according to one embodiment of the present invention;

FIG. 3 shows a cross-sectional view of a slitter device depicting blade wear and resulting misalignment of the blades that can be remedied by embodiments of the present invention; and

FIG. 4 shows cross-sectional view of a slitter device according to another embodiment of the present invention.

### DETAILED DESCRIPTION OF THE INVENTION

The present inventions now will be described more fully hereinafter with reference to the accompanying drawings, in which some, but not all embodiments of the invention are shown. This invention may be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

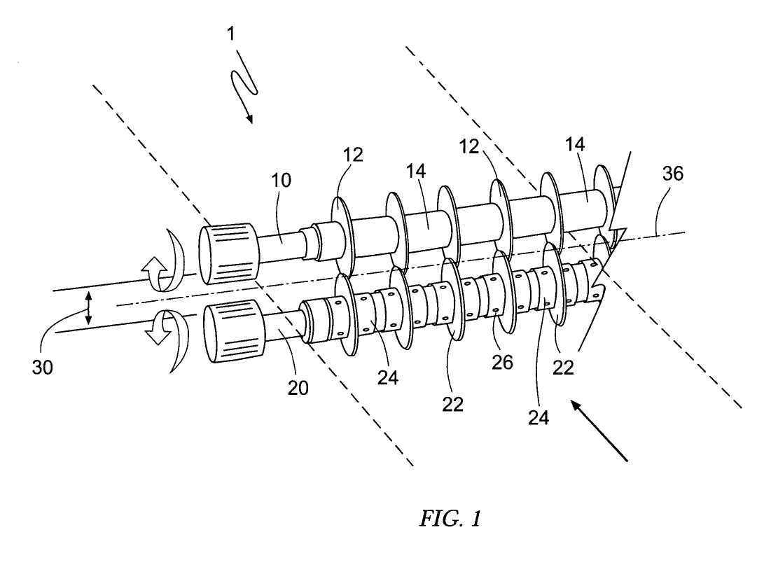

FIG. 1 shows one embodiment of a slitter device 1 according to the present invention, comprising a first rotatable shaft 10 extending axially through a first cutting blade 12. The first cutting blade 12 may be fixed with respect to the first rotatable shaft 10. The first cutting blade 12 is axially separated from adjacent cutting blades on the first rotatable slitter shaft 10 by, for example, spacers 14. A second rotatable shaft 20 is positioned substantially parallel to the first rotatable shaft 10. The second rotatable shaft 20 extends axially through a second cutting blade 22. Though the slitter device 1 is described herein in terms of single first and second cutting blades 12,22, one skilled in the art will appreciate that a plurality of such blades may be provided on each of the respective first and second rotatable shafts 10,20, wherein such a configuration is shown in the accompanying figures. In one embodiment, for example, the rotatable shafts 10,20 have a length of about 110 inches and extend through 24 sets of complementary cutting blades 34. In such an embodiment, the profiles of the first and second cutting blades 12,22 are substantially circular and have an overall diameter of, for example, about 10.5 inches, while the first and second rotatable shafts 10,20 are also substantially circular and have an outer diameter of, for example, about 6 inches.

In one embodiment, the second cutting blade 22 is secured via a collar 24, to the second rotatable shaft 20. The collar 24 may be secured to the second rotatable shaft 20 by a securing member 26 such as, for example, a set screw extending radially through the collar 24, to provide a fixed engagement between the collar 24 and the second rotatable shaft 20. Once the collar 24 is secured to the second rotatable shaft 20, the associated second cutting blade 22 becomes axially fixed relative to the second rotatable shaft 20. However, the securing member 26 may be selectively disengaged from the second rotatable shaft 20 so that the collar 24 and associated second cutting blade 22 can be axially moved relative to the second rotatable shaft 20.

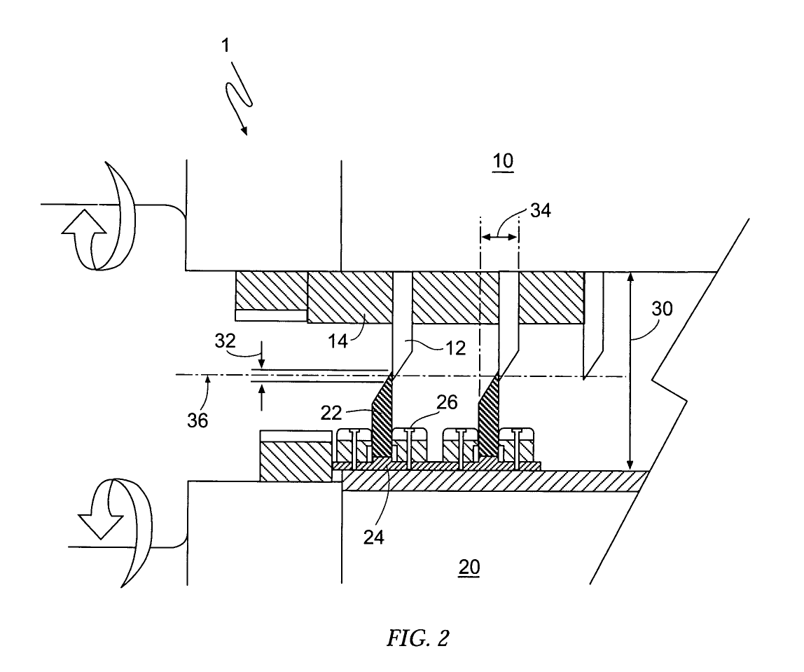

As shown in FIG. 2, the second cutting blade 22 is positioned with respect to the first cutting blade 12 so as to define a cutting position wherein the first and second cutting blades 12, 22 form a set of complementary cutting blades 34 that cooperate to cut the sheet material. In the cutting position, the first and second cutting blades 12,22 are axially positioned along the respective rotatable shafts 10,20 to be immediately adjacent to each other, and to extend radially from the respective first and second rotatable shafts 10, 20 so as to radially overlap in the space 30 defined between the shafts 10,20. In one embodiment, the first and second cutting blades 12,22 may be separated, for example, by an axial space of about 0.003 to 0.005 inches, with a radial overlap between the first and second cutting blades 12,22 of about 0.25-0.50 inches and, in some instances, about 0.375 inches.

Each cutting blade 12, 22 may be formed of, for example, hardened and tempered cold-finished steel alloy, such as AISI E52100, or any other material suitable for cutting the sheet material. Further, the collar 24 may be formed of, for example, stainless steel tubing, such as Type 316, S31600 stainless steel, while the securing member 26 (including those embodiments where the securing member 26 includes first and second sleeves 26a, 26b) may be formed of specialized stainless steel alloy, such as for instance, Nitronic 60, UNS S21800, or other suitable material. One skilled in the art, however, will appreciate that such material selection for each particular component is provided herein for example only, and is not intended to be limiting in any respect for the respective component.

In operation, the sheet material is fed toward the space 30 defined between the shafts 10,20, in perpendicular relation to the axes of the shafts 10,20. Accordingly, the shafts 10,20 may be configured to counter-rotate, as shown in FIG. 1, such that the blades 12,22 angularly converge toward the sheet material being fed toward the space 30 defined between the shafts 10,20. The sheet material may comprise, for example, reconstituted tobacco sheet (such as, for instance, an R.J. Reynolds Tobacco Company so-called G-7 reconstituted tobacco sheet), paper stock, laminate material, or other sheet material. The counter-rotation of the sets of complementary cutting blades 34 cuts the sheet material into ribbons having widths substantially equal to the axial distance between adjacent sets of complementary cutting blades 34.

The rotatable shafts 10,20 may be driven, for example, by appropriate motors and gearing mechanisms, or other drive mechanisms capable of, for instance, adjusting the relative speeds of the rotatable shafts 10,20. One skilled in the art will appreciate that many different types of motors and/or gearing or drive mechanisms, or combinations thereof may be used, as appropriate or desired, to drive the rotatable shafts 10,20 in the manner described herein, wherein such types of motors and/or gearing or drive mechanisms are independent of the functionality of the slitter device 1 according to various embodiments of the present invention. According to one embodiment, the sheet material is forwarded to the slitter device 1 at about 400 feet per minute, and the shafts 10,20 are configured to counter-rotate at an angular speed of within about ±5% of the linear feed rate of the sheet material. In one advantageous embodiment, the shafts 10,20 are configured to counter-rotate at an angular speed of about 2% greater than the linear feed rate of the sheet material. In addition, the slitter device 1 may be fitted with a conveyor belt or other feed mechanism (not shown) for conveying the sheet material toward the cutting blades 12,22. One skilled in the art will appreciate, however, that other conveyor devices such as, for example, roller drums, may be implemented to feed the sheet material, wherein such conveyor devices may, in some instances, be assisted by vacuum mechanisms or the like for ensuring efficient feeding of the sheet material.

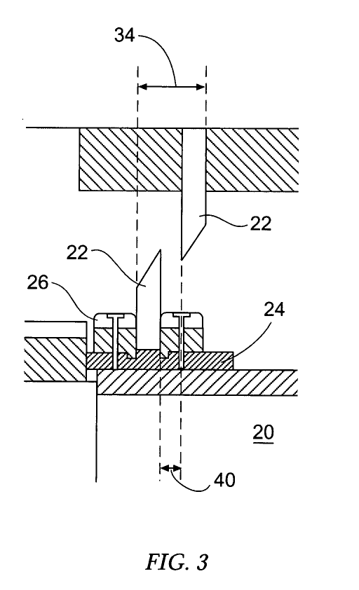

As shown in FIG. 3, after a period of operation one or both of the cutting blades 12,22 in a set 34 may be sufficiently worn such that the cutting position, or the axial space of about 0.003 to 0.005 inches between the cutting blades 12,22, is no longer maintained. Wear of the blades may be cause by, for example, contact with the respective complementary cutting blade, interaction of the cutting blades 12,22 with irregular components that make up the sheet material, or interaction of the cutting blades 12,22 with the sheet material itself. As a result of blade wear, an axial gap 40 (greater than about 0.005 inches) is formed between the opposing radially overlapping surfaces of complementary cutting blades 12, 22 such that the cutting blades 12,22 are no longer in the cutting position, thereby adversely affecting the cutting performance of the slitter device 1.

As shown in FIG. 3, according to one advantageous aspect of the present invention, the second cutting blade 22, is axially movable relative to the second rotatable shaft 20 so as to allow the second cutting blade 22 to be adjusted to restore the cutting position relative to the first cutting blade 12, as shown in FIG. 2. Such an adjustment of the second cutting blade 22, may be accomplished by, for example, sufficiently disengaging the securing member 26 from the fixed engagement with the shaft 20 and axially adjusting the collar 24 and/or the second cutting blade 22 with respect to the first cutting blade 12 so as to restore the cutting position.

One skilled in the art will appreciate that the axial adjustment of the second cutting blade may be achieved using various types of collars and securing members. For example, the collar 24 may comprise a non-contiguous ring having opposing portions defining an angular gap. The securing member may further be configured to operably engage the portions of the ring, across the gap, wherein the securing member is capable of reducing the gap so as to provide a compression fit or other manner of a friction-type fit between the collar 24 and the second rotatable shaft 20.

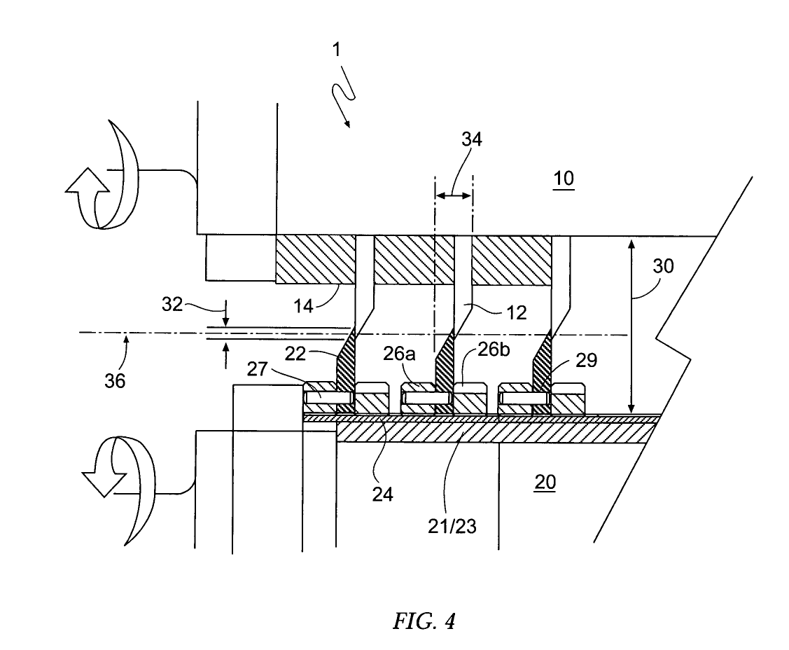

According to another advantageous aspect of the present invention, as shown in FIG. 4, the second rotatable shaft 20 extends through a collar 24 having a threaded radially-outward surface, wherein the radially-outward surface in configured to, in turn, extend axially through the second cutting blade 22. Each collar 24 extends axially over a length of about 6 inches. In such an embodiment, the securing member 26 comprises a first sleeve 26a having a pin 27 engaged therewith and extending axially therefrom, and a second sleeve 26b configured to cooperate with the first sleeve 26a so as to axially and rotationally fix the second cutting blade 22 with respect to the collar 24. The collar 24 is rotationally fixed with respect to the second rotatable shaft 22 by an axially-extending key 21 extending between the collar 24 and the second rotatable shaft 20. In some embodiments the collar 24 may also be axially fixed with respect to the second rotatable shaft 20 by abutting an adjacent collar 24, wherein a series of abutting collars 24 may be axially secured with respect to the second rotatable shaft 20, for example, by end nuts at opposing ends of the second rotatable shaft 20.

As shown in FIG. 4, the second cutting blade 22 is axially secured between the first and second sleeves 26a,26b. More particularly, each of the first and second sleeves 26a,26b may include a threaded radially-inward surface corresponding to and configured to be capable of threadedly engaging the threaded radially-outward surface of the collar 24. In some embodiments, the sleeves 26a,26b may comprise, for example, threaded nuts, each having a radially-outward surface defining spanner wrench flats for facilitating axial adjustment thereof with respect to the collar 24 by a spanner wrench. In such a configuration, the first sleeve 26a is threaded onto the collar 24 to a desired axial position with respect thereto. The second cutting blade 22 is then installed about the collar 24 and into axial engagement with the first sleeve 26a such that the pin 27 extending axially from the first sleeve 26a engages a corresponding axially-extending aperture 29 defined by the second cutting blade 22. The second sleeve 26b is then threaded onto the collar 24, opposite the second cutting blade 22 from the first sleeve 26a, such that the second cutting blade 22 is secured therebetween.

In order to axially adjust the second cutting blade 22 with respect to the collar 24, and thus the second rotatable shaft 20, the second sleeve 26b first rotated so as to be moved axially away from the second cutting blade 22. The first sleeve 26a, having the second cutting blade 22 engaged therewith via the pin 27/aperture 29 interaction, is then rotated so as to axially move the second cutting blade 22 to the desired axial position on the collar 24. Once the second cutting blade 22 is adjusted to the desired axial position with respect to the complementary first cutting blade 12 with the first sleeve 26a, the second sleeve 26b is axially moved back into engagement with the second cutting blade 22. The first and second sleeves 26a,26b are then concurrently counter-rotated so as to be directed in opposite axial direction, toward the second cutting blade 22. One skilled in the art will appreciate that the counter-rotation of the first and second sleeves 26a,26b serves to compress the second cutting blade 22 therebetween and the resulting compressive interaction between the collar threads and the sleeve threads axially and rotationally secures the second cutting blade 22 and the first and second sleeves 26a,26b with respect to the collar 24. Accordingly, in this manner, the second cutting blade 22 is axially and rotationally secured between the first and second sleeves 26a,26b.

Further embodiments of the slitter device 1 may provide for axial blade adjustment on more than one shaft so as to provide additional adjustment capabilities for the slitter device 1. Such a configuration may be advantageous in instances where, for example, the desired width of the ribbons of the sheet material cut by the slitter device 1 must be changed.

According to the various embodiments of the present invention, the second cutting blade 22 may be axially adjusted with respect to the second rotatable shaft 20, individually and independently to other cutting blades disposed along the same or an opposing rotatable shaft, and without effect on or interaction with other adjustable or non-adjustable cutting blades disposed along the second rotatable shaft 20, wherein such a principle may also be extended to instances involving adjustable cutting blades on more than one shaft.

While the profile of each of the cutting blades 12,22 depicted in FIGS. 1-3 is substantially circular, the cutting blades 12, 22 may have a variety of profiles as will be appreciated by one skilled in the art. Such blade profiles may include, for example, generally circular shapes having angled “saw teeth”, multi-sided polygons, and other shapes suitable for producing the necessary cutting action of sheet material. In addition, the configuration of the lateral cross-section of the blades 12,22 may vary from the unilateral taper configuration shown in FIG. 1, and may include other configurations suitable for providing the necessary cutting performance without departing from the spirit of the invention.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A slitter device, comprising:
a first rotatable shaft extending axially through a first cutting blade;
a second rotatable shaft disposed substantially parallel to the first rotatable shaft; and
a second cutting blade having the second rotatable shaft extending axially therethrough, the second cutting blade being axially movable relative to the second rotatable shaft such that the second cutting blade can be adjusted to maintain a cutting position adjacent to the first cutting blade so as to compensate for blade wear.

2. A device according to claim 1, further comprising a collar having the second rotatable shaft extending axially therethrough, the collar being configured to be capable of fixedly engaging the second rotatable shaft so as to axially fix the second cutting blade with respect to the second rotatable shaft.

3. A device according to claim 2 further comprising at least one securing member capable of operably engaging the collar so as to secure the collar to the second rotatable shaft.

4. A device according to claim 3, wherein the securing member comprises a fastening device configured to be capable of extending radially through the collar so as to provide a fixed engagement between the collar and the second rotatable shaft.

5. A device according to claim 3, wherein the collar comprises a non-contiguous ring, defining an angular gap and wherein the securing member comprises a fastening device capable of operably engaging the collar, across the gap, so as to reduce the gap and provide a friction engagement between the collar and the second rotatable shaft.

6. A device according to claim 1, wherein at least one of the first and second cutting blades is substantially circular in profile.

7. A device according to claim 1, wherein at least one of the first and second cutting blades is non-circular in profile.

8. A device according to claim 2, wherein the collar further comprises an axially-extending keyway and a threaded radially-outward surface, and the device further includes a key configured to be operably engaged between the collar keyway and the second rotatable shaft so as to rotationally fix the collar with respect to the second rotatable shaft.

9. A device according to claim 8, wherein the radially-outward surface of the collar is configured to extend through the second cutting blade.

10. A device according to claim 8, further comprising:
a first sleeve having the collar extending therethrough and configured to engage the threaded radially-outward surface of the collar; a pin operably engaged with the first sleeve and extending axially therefrom;
an axial aperture defined by the second cutting blade and configured to receive the pin so as to rotationally fix the second cutting blade with respect to the first sleeve;
a second sleeve having the collar extending therethrough, the second sleeve being arranged opposite the second cutting blade from the first sleeve and being capable of cooperating with the first sleeve to rotationally fix the second cutting blade with respect to the collar.
